(19) United States
(12) Patent Application Publication
(10) Pub. No.: US 2022/0074150 A1
(43) Pub. Date: Mar. 10, 2022

(54) SWEEPER

(71) Applicant: AERO-TECH PTY LTD., Nunawading, Victoria (AU)

(72) Inventors: Warwick TOZER, Nunawading (AU); Stuart TOZER, Nunawading (AU)

(73) Assignee: AERO-TECH PTY LTD., Nunawading, Victoria (AU)

(21) Appl. No.: 17/312,987

(22) PCT Filed: Nov. 26, 2019
(86) PCT No.: PCT/AU2019/051295

§ 371 Date: Jun. 11, 2021

(30) Foreign Application Priority Data
Dec. 12, 2018 (AU) 2018904718
Aug. 21, 2019 (AU) 2019903059
Sep. 3, 2019 (AU) 2019100997

(51) Int. Cl. E01H 1/04

(52) U.S. Cl. CPC E01H 1/04

(57) ABSTRACT

A sweeper including a mat for sweeping a ground surface by moving the mat over the ground surface in a direction of travel substantially transverse to a leading edge of the mat, the mat having at least one slot extending therethrough and disposed transversely relative to the direction of travel whereby in use of the mat debris can pass through the slot over a trailing edge of the slot to collect on an upper surface of the mat, wherein the sweeper includes a cover over the mat for trapping debris on said upper surface of the mat.

### FIELD OF THE INVENTION

The present invention relates to a sweeper for sweeping a ground surface and more specifically, but not exclusively, to a device for sweeping a playing field such as a tennis court or the like.

### BACKGROUND OF THE INVENTION

Outside playing courts, such as tennis courts, are often prone to accumulating leaves or other debris on their surface which must be periodically removed.

Australian patent 628556 describes a mat for sweeping a surface, the mat comprising slots through which debris, such as leaves or sticks, can pass to collect on the upper surface of the mat.

The mat may be composed of a semi-flexible material, such as rubber or a suitable polymeric material.

The slots may be elongate with the longitudinal axis of each slot facing generally in the direction of travel of the mat. The trailing edge of each slot may be chamfered to lift debris onto the upper surface of the mat. The trailing edge of each slot may face perpendicularly to the direction of travel or may be inclined, for example at 45 degrees. In the mat, all of the slots may be inclined to the direction of travel, or some may be inclined with others being perpendicular to the direction of travel.

In one particularly advantageous form, the mat is of a grid-like construction for “bagging” a clay tennis court, with portions of the grid being removed to define the slots. Thus “bagging” of the court periodically during play will also serve to remove leaves and other debris from the surface of the court.

In a particular form, the mat is of grid-like construction, presenting an array of apertures, typically of rectangular form, and about 12.5 mm side dimension, arranged with sides at about 45 degrees to the intended direction of travel of the mat. The grid has small holes to allow sand, rubber or other infill collected by the sweeper to filter back down onto the surface.

Arrangements as above described have been found particularly useful for, among other things, sweeping debris from tennis courts and sports fields.

Australian Patent No. 781906 by the present inventor relates to a previous debris collection mat invention and the entirety of that document is incorporated herein by reference.

The inventor has determined that it would be advantageous to provide a sweeper which obviates or at least alleviates one or more disadvantages of existing sweepers, or at least provides a useful alternative.

### SUMMARY OF THE INVENTION

In accordance with one aspect of the present invention there is provided a sweeper including a mat for sweeping a ground surface by moving the mat over the ground surface in a direction of travel substantially transverse to a leading edge of the mat, the mat having at least one slot extending therethrough and disposed transversely relative to the direction of travel whereby in use of the mat debris can pass through the slot over a trailing edge of the slot to collect on an upper surface of the mat, wherein the sweeper includes a cover over the mat for trapping debris on said upper surface of the mat.

Preferably, the sweeper includes an upwardly extending flange across a rear portion of the upper surface of the mat.

In a preferred form, the sweeper includes at least one skid or wheel at a front portion of the mat for raising a leading edge of the mat above the ground surface.

Preferably, the sweeper includes a pair of opposed skids, or wheels, one at each side of a front portion of the mat for raising a leading edge of the mat above the ground surface.

In accordance with another aspect of the present invention there is provided a sweeper including a mat for sweeping a surface by moving the mat over the surface in a direction of travel substantially transverse to a leading edge of the mat, the mat having at least one slot extending therethrough and disposed transversely relative to the direction of travel whereby in use of the mat debris can pass through the slot over a trailing edge of the slot to collect on an upper surface of the mat, wherein the sweeper includes an upwardly extending flange across a rear portion of the upper surface of the mat.

In accordance with another aspect of the present invention there is provided a sweeper including a mat for sweeping a ground surface by moving the mat over the ground surface in a direction of travel substantially transverse to a leading edge of the mat, the mat having at least one slot extending therethrough and disposed transversely relative to the direction of travel whereby in use of the mat debris can pass through the slot over a trailing edge of the slot to collect on an upper surface of the mat, wherein the sweeper includes at least one riser at a front portion of the mat for raising a leading edge of the mat above the ground surface.

Preferably, the at least one riser is in the form of at least one skid or wheel.

Preferably, the sweeper includes a handle coupled to a leading edge of the mat for dragging the sweeper across the ground surface by hand or towed by a vehicle. More preferably, the handle is in the form of a rope coupled to opposed end portions of the leading edge of the mat or by a tow handle.

### BRIEF DESCRIPTION OF THE DRAWINGS

The invention is further described by way of non-limiting example only, with reference to the accompanying drawings in which:

FIG. 1 is a side perspective view of a sweeper in accordance with an example of the present invention;

FIG. 2 is a detailed view of a rear portion of the sweeper of FIG. 1;

FIG. 3 shows a top perspective view of a sweeper having a cover in accordance with an example of the present invention;

FIG. 4 shows a side perspective view of the sweeper of FIG. 3, with the cover partially upturned;

FIG. 5 shows a top perspective view of part of the sweeper of FIG. 4, depicted with the cover upturned;

FIG. 6 shows detail of a portion of a mat of the sweeper of FIG. 5;

FIG. 7 shows a sweeper having a pair of skids or wheels in accordance with an example of the present invention;

FIG. 8 shows a top perspective view of the sweeper of FIG. 7, shown with a cover partially upturned;

FIGS. 9 to 15 show an alternative example of a sweeper in accordance with the present invention;

FIGS. 16 to 18 show yet a further sweeper in accordance with the present invention; and

FIG. 19 shows an upper perspective view of another sweeper in accordance with an example of the present invention.

### DETAILED DESCRIPTION OF THE PREFERRED EMBODIMENTS

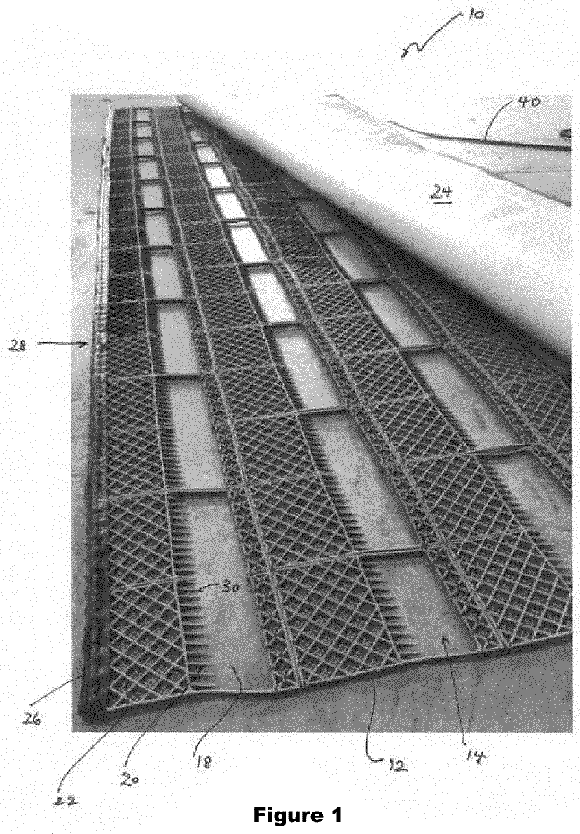

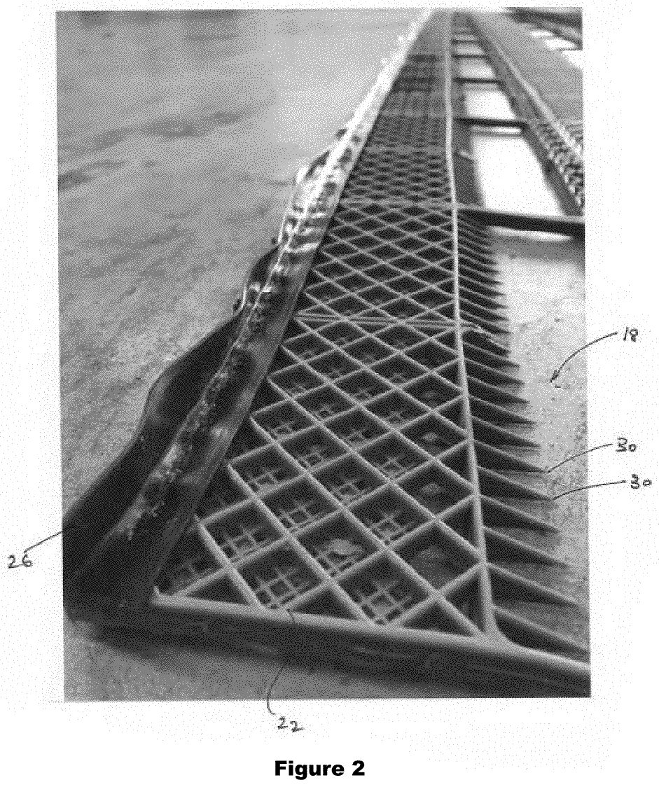

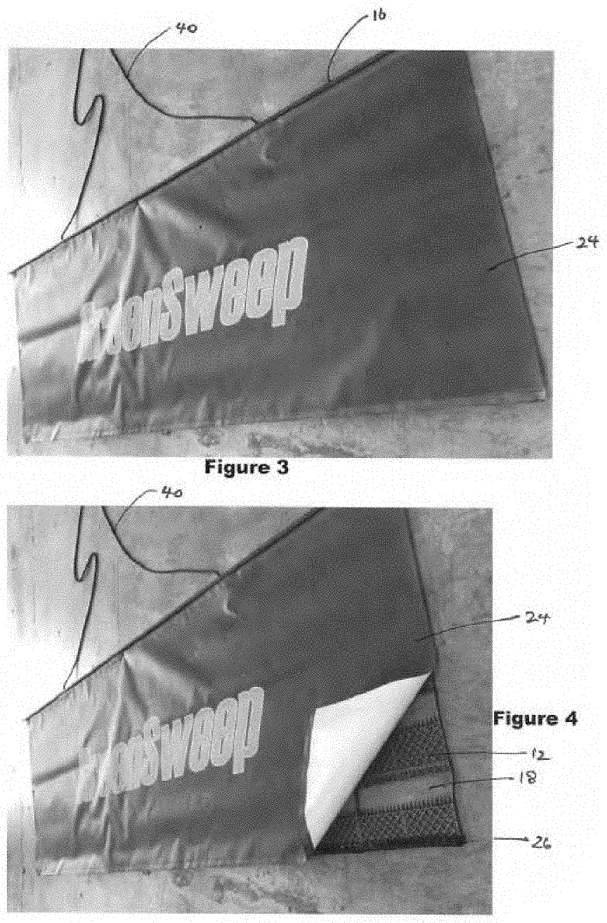

With reference to FIGS. 1 to 8 of the drawings, there is shown a sweeper for sweeping a ground surface such as a sporting ground or tennis court, the sweeper having improvements so as to increase effectiveness in removing debris from the ground surface.

More specifically, with reference to FIGS. 1 to 8, there is shown a sweeper 10 including a mat 12 for sweeping a ground surface 14 by moving the mat 12 over the ground surface 14 in a direction of travel substantially traverse to a leading edge 16 of the mat 12. The mat 12 has at least one slot 18 extending therethrough and disposed transversely relative to the direction of travel whereby in use of the mat 12 debris can pass through the slot 18 over a trailing edge 20 of the slot 18 to collect on an upper surface 22 of the mat 12. The sweeper 10 includes a cover 24 over the mat 12 for trapping debris on the upper surface 22 of the mat 12.

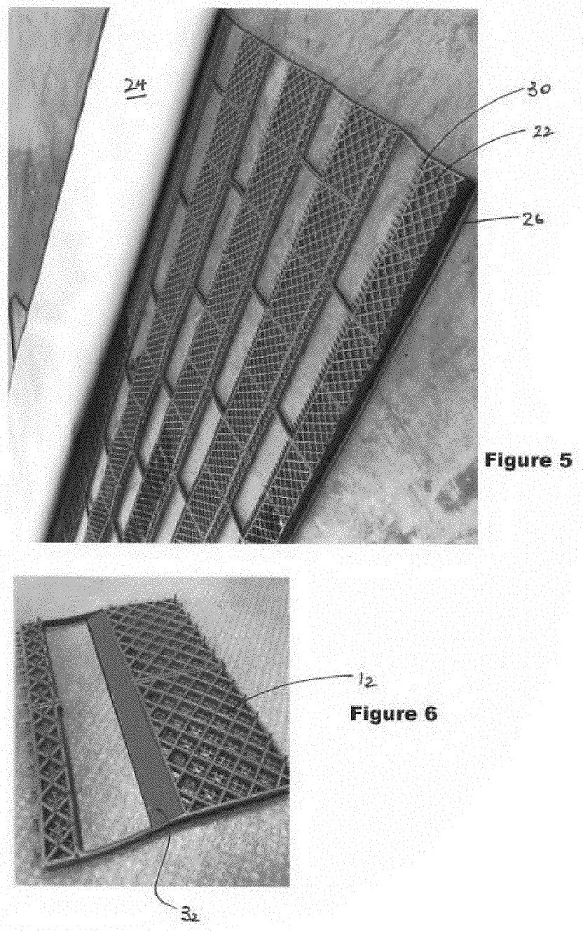

The sweeper 10 may include an upwardly extending flange 26 across a rear portion 28 of the upper surface 22 of the mat 12. The upwardly extending flange 26 is clearly depicted in FIGS. 1, 2, 4, 5 and 8. The cover 24 is clearly depicted in FIGS. 1, 3, 4, 5, 7 and 8. Advantageously, the cover 24 and the upwardly extending flange 26 serve to improve the collection and retention of debris on the upper surface 22 of the mat 12 as the sweeper 10 is dragged along the ground surface 14. Detail of the mat 12 is shown in FIG. 5, wherein the trailing edge 20 of the slot 18 is defined by a toothed edge of the mat 12. The teeth 30 are equally spaced and are generally parallel to a direction of travel of the sweeper 10. With reference to FIG. 6, there is shown a portion of a mat 12 in accordance with an alternative example wherein the mat has a transverse blade 32 rather than the teeth 30 shown in the example of FIG. 5.

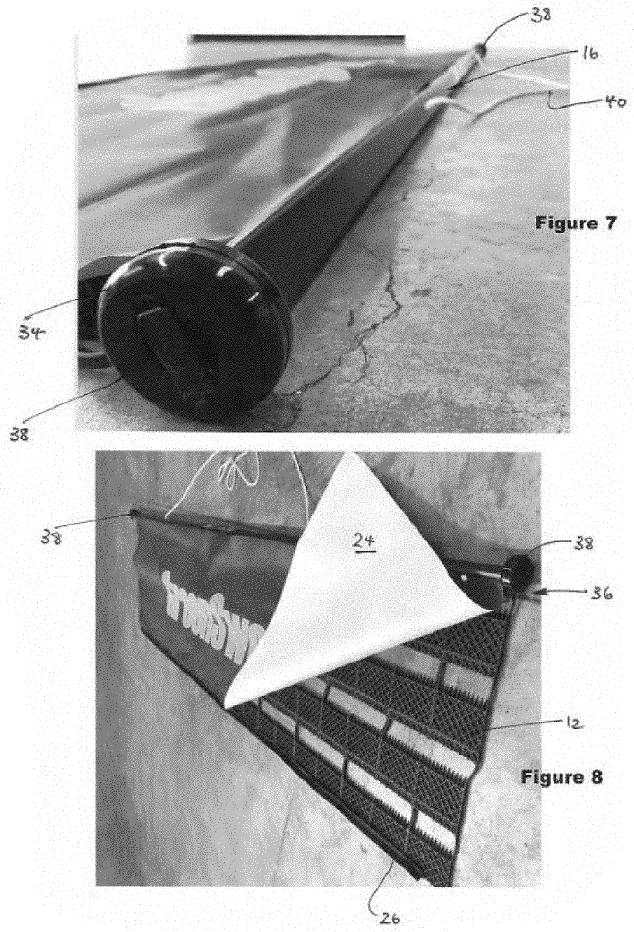

Turning to FIGS. 7 and 8, the sweeper 10 may include at least one riser 34 at a front portion 36 of the mat 12 for raising a leading edge 16 of the mat 12 above the ground surface 14. The riser 34 may be in the form of a skid or wheel 38, and the sweeper actually depicted in FIGS. 7 and 8 includes a pair of opposed skids or wheels 38, one at each side of the front portion 36 of the mat 12 for raising the leading edge 16 of the mat 12 above the ground surface 14.

The sweeper 10 may include a handle 40 coupled to the leading edge 16 of the mat 12 for dragging the sweeper 10 across the ground surface 14 by hand. The handle 40 may be in the form of a rope or tow handle coupled to opposed end portions of the leading edge 16 of the mat 12. A tow handle could alternatively be coupled to a central portion of the leading edge 16.

Accordingly, the applicant has determined that:

1. An ‘L’ shape ledge 26 would be attached to the rear of the sweeper or at the rear of each transverse row of the mat 12 to improve debris retention (eg. reduce debris falling off the back), which may sometimes occur in use; and

2. A mesh cover/flap 24 would be attached to the front of the sweeper 10 that would rest on top to keep leaves and debris trapped underneath and reduce the chance of blowing off in windy conditions or when travelling at speeds faster than walking pace towing with a small vehicle. The mesh flap 24 would only be attached at the front leaving three sides loose so that emptying is fast and easy lifting and shaking by the front aluminium tow bar, as usual.

The mesh flap 24 may extend over the rear upstand 26 and when the two are combined this greatly increases collection efficiency and holding capacity. This new mesh flap system is unique in that it allows leaves to enter into the catchment area keeping debris trapped under its own weight and is alternatively emptied from the front aluminium bar.

Two skids or wheels 38 attached to the front tow bar keep the bar from hitting and fouling on the ground, and allowing it to automatically set the correct towing height, ensuring there is clearance for debris to pass underneath and into the capture zones. The risers may be in the form of skids 38 which are not rotating wheels. The skids 38 may be fixed to the bar as shown in FIGS. 7 and 8.

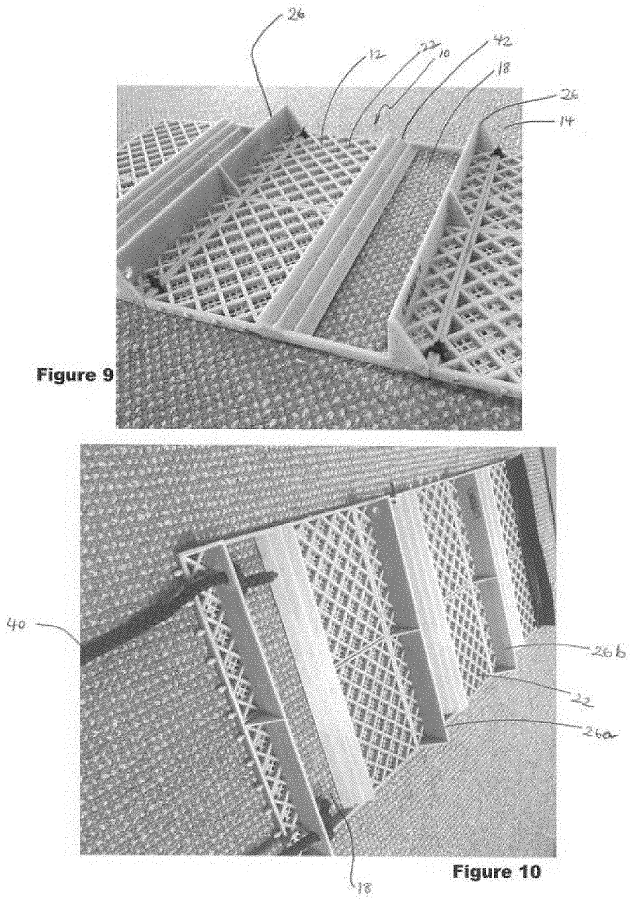

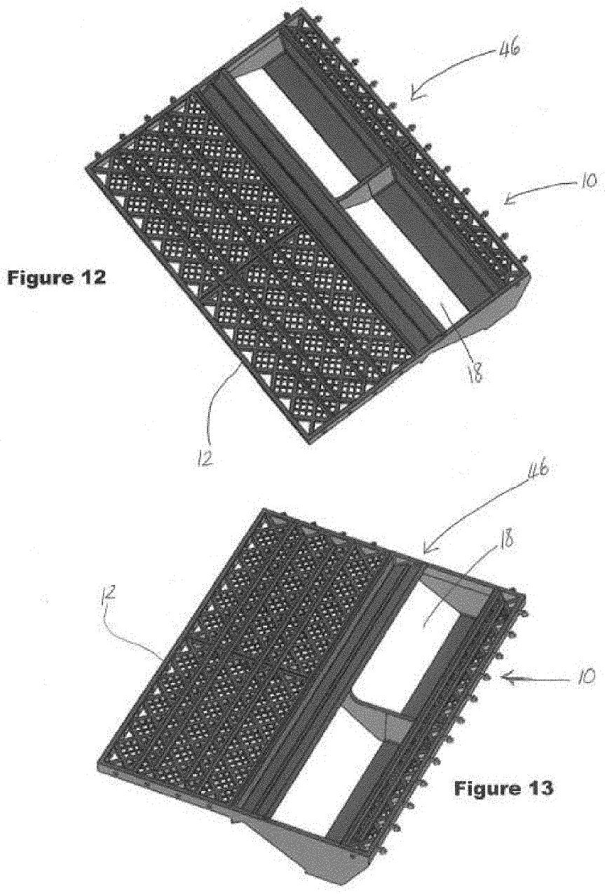

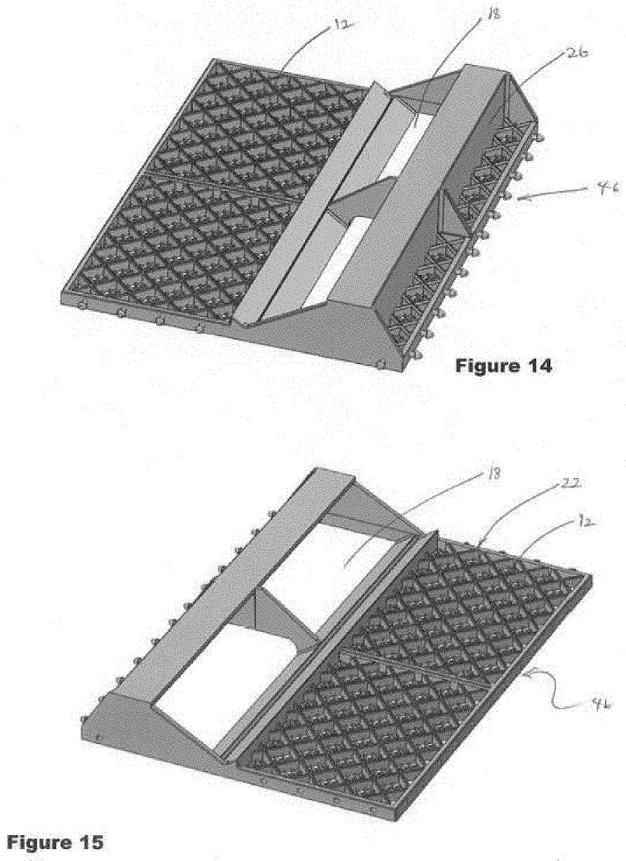

With reference to FIGS. 9 to 15, there is shown a sweeper 10 in accordance with another example of the present invention. The sweeper 10 of FIGS. 9 to 15, has some features common with the sweeper 10 of FIGS. 1 to 8, and like features are indicated with like reference numerals. In particular, the sweeper 10 shown in FIGS. 9 to 15 has steps 42 incorporated into a blade of the sweeper 10 to increase collection efficiency by capturing debris earlier. Also, as shown in FIGS. 12 to 15, the sweeper 10 has a lip 44 at the top of the flange 26 to assist in keeping debris retained behind it. In addition, the flange 26 is in the form of a built-in upstand which becomes the retainer edge once it is assembled.

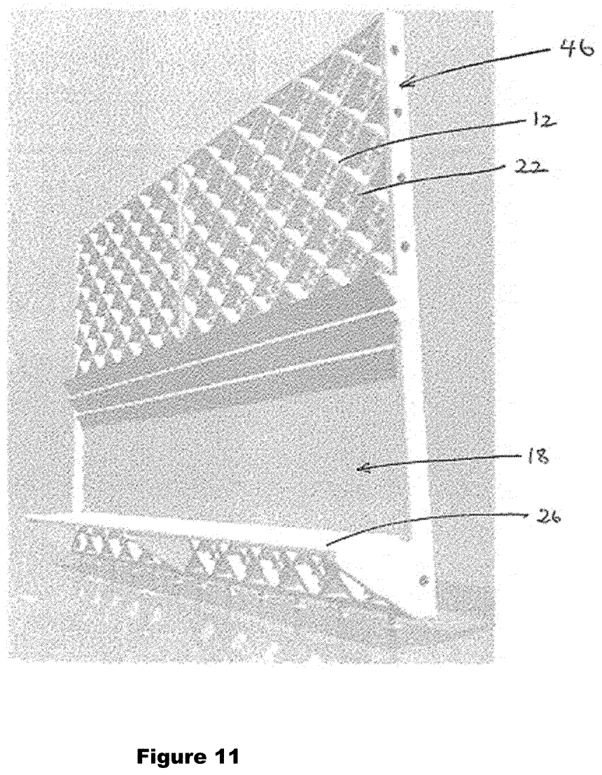

The sweeper 10 may be formed as a series of modules which are linked together to form the sweeper 10. Each module 46 may be in the form shown in FIG. 11, or in the modified form with the lip 44 shown in FIGS. 12 to 15. Each module 46 may have apertures 48 to enable infill from the ground surface to filter down from the collected foreign object debris on the upper surface 22, through the apertures 48 to be returned to the ground surface.

With reference to FIGS. 12 to 15 in particular, the upwardly extending flange 26 includes a raised lip 44 extending forwardly from the flange 26. The flange 26 may be in the form of an upstand integrally formed with the mat 12. The sweeper 10 may be formed as a set of modules 46 which are linked together to form the sweeper 10, each module 46 including a slot 18 and an associated upwardly extending flange 26. The sweeper 10 may include a first upwardly extending flange 26a (see FIG. 10) serving as a barrier across the upper surface 22 of the mat 12, and a second upwardly extending flange 26b serving as a barrier across the upper surface 22 of the mat 12. The first upwardly extending flange 26a may be located forwardly of the second upwardly extending flange 26b, and the first upwardly extending flange 26a may be parallel to the second upwardly extending flange 26b. The sweeper 10 may include a plurality of flanges 26, a plurality of slots 18, and each pair of successive flanges 26 is separated by one of said slots 18.

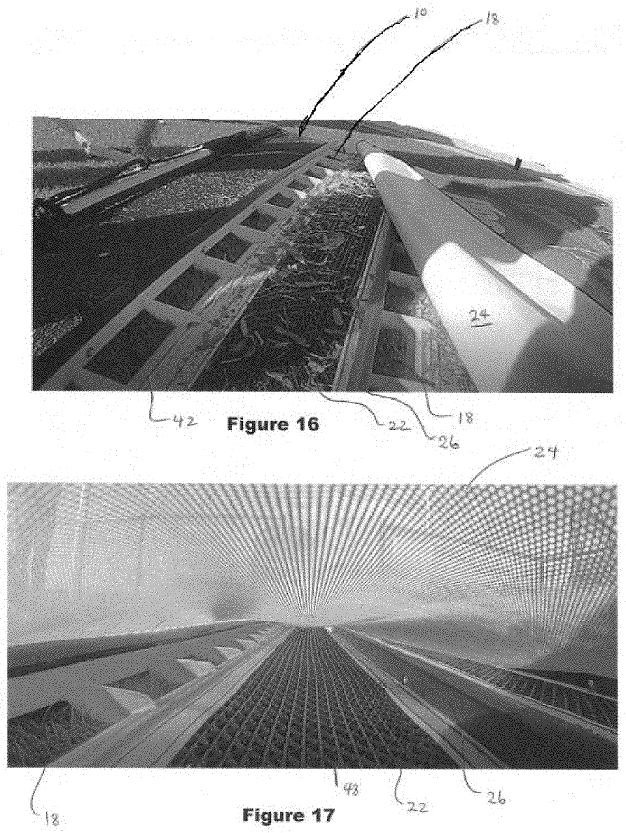

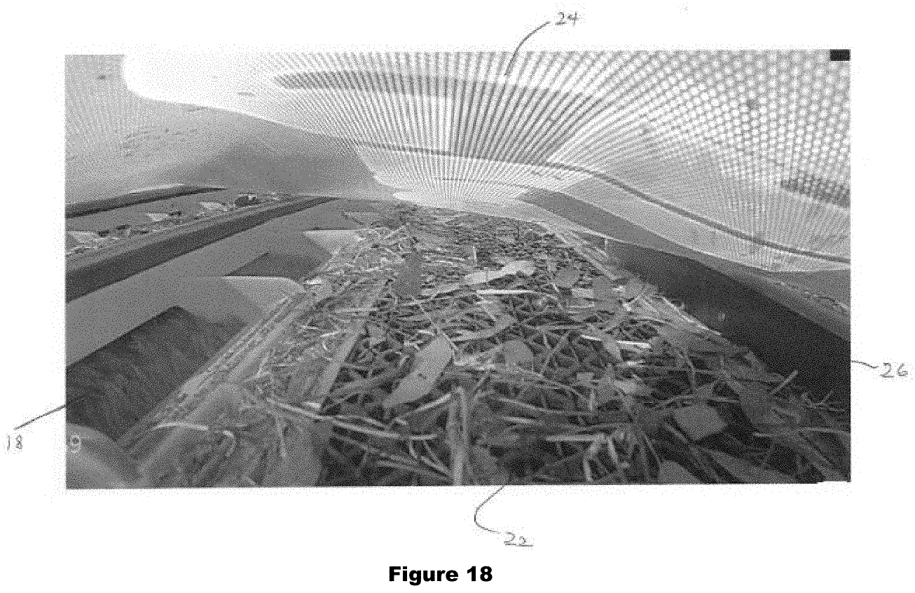

FIGS. 16 to 18 show a sweeper 10 in accordance with yet another example of the present invention. In this example, the mat 12 is formed of a rubber mat material having alternating wavy and straight elements forming apertures 48 through which infill can be returned to the ground surface. Such infill may be, for example, sand or rubber pellets/particles such as those of the kind used on artificial grass sporting surfaces. As depicted, the mat 12 has apertures 48 to allow infill collected by the sweeper 10 from the ground surface 14 to filter back down from the upper surface 22, through the apertures 48 and onto the ground surface 14. The apertures 48 may take different forms. For example, as shown in FIGS. 9 to 15, the mat 12 may be of grid-like construction with an array of said apertures 48.

With regard to the steps 42, the sweeper 10 (see FIG. 9 or FIG. 16) may include at least one step 42 extending as a hurdle rearwardly of the slot 18 such that foreign object debris travels over the at least one step 42 by virtue of momentum and the step 42 prevents unwanted forward travel of the debris so as to retain the debris on the mat 12 rather than having the debris fall back through the slot 18 to the ground surface 18. The sweeper 10 may include a plurality of steps 42 (rather than a single step) extending as a hurdle rearwardly of the slot 18 such that foreign object debris from the slot 18 travels rearwardly over the steps 42 by virtue of momentum and the steps prevent unwanted forward travel of the debris. The steps 42 may be formed with a generally sawtooth profile (see FIG. 9), each tooth having a ramped forward face and a vertical rearward face.

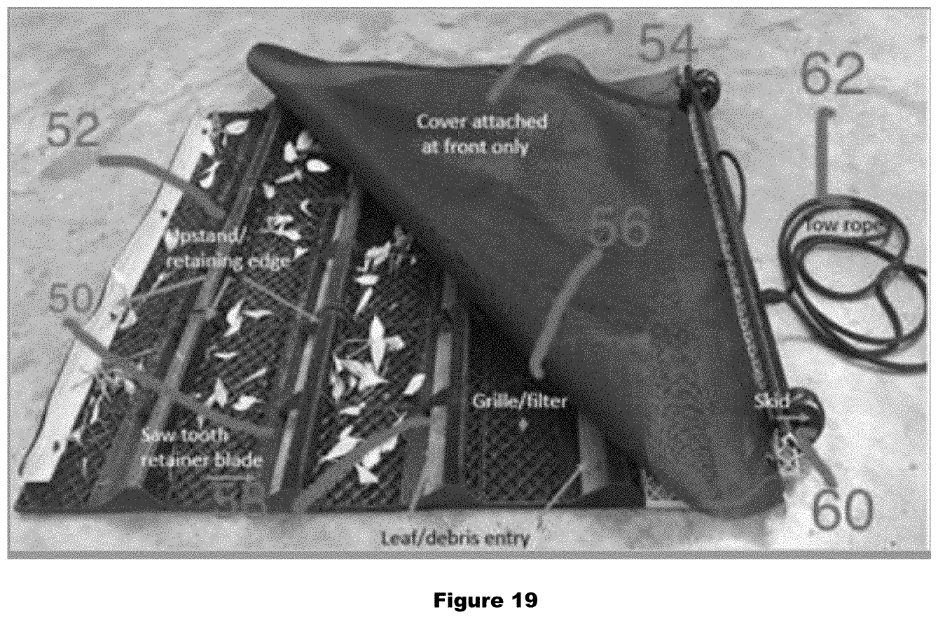

FIG. 19 shows a top view of a further example of the present invention wherein the sweeper 10 includes a saw tooth retainer blade 50, an upstand/retaining edge 52, a cover 54 attached only at the front, a grille/filter 56 formed of mesh which retains leaves but enables filtering through of desirable particles (such as particles specifically intended to operate as part of an artificial grass surface), openings 58 for leaf/debris entry, skids 60 and a tow rope 62.

It will be appreciated from the above that the present invention may provide a sports field/tennis court sweeper that:
Has a solid “sawtooth” elevated collection blade;
Has built-in rear retaining upstand edges to reduce the chance of collected debris falling off the back;
Easily glides over a synthetic surface, picks up debris by way of friction but allows rubber infill or sand to filter back onto the surface;
Does not “snag” or “hook up” as previous sweepers with individual teeth can do on many synthetic grass surfaces;
May include a mesh cover or flap attached to the front allowing easy emptying; and
May include skid or wheels on the leading edge to set the sweeping height allowing debris to easily pass under and enter the capture area.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge.

1. A sweeper including a mat for sweeping a ground surface by moving the mat over the ground surface in a direction of travel substantially transverse to a leading edge of the mat, the mat having at least one slot extending therethrough and disposed transversely relative to the direction of travel whereby in use of the mat debris can pass through the slot over a trailing edge of the slot to collect on an upper surface of the mat, wherein the sweeper includes a cover over the mat for trapping debris on said upper surface of the mat.

2. A sweeper as claimed in claim 1, wherein the sweeper includes an upwardly extending flange across a rear portion of the upper surface of the mat.

3. A sweeper as claimed in claim 1, wherein the sweeper includes at least one skid at a front portion of the mat for raising a leading edge of the mat above the ground surface.

4. A sweeper as claimed in claim 3, wherein the sweeper includes a pair of opposed skids, one at each side of a front portion of the mat for raising a leading edge of the mat above the ground surface.

5. A sweeper including a mat for sweeping a surface by moving the mat over the surface in a direction of travel substantially transverse to a leading edge of the mat, the mat having at least one slot extending therethrough and disposed transversely relative to the direction of travel whereby in use of the mat debris can pass through the slot over a trailing edge of the slot to collect on an upper surface of the mat, wherein the sweeper includes an upwardly extending flange across an upper surface of the mat.

6. A sweeper as claimed in claim 5, wherein the upwardly extending flange extends across a rear portion of the upper surface of the mat.

7. A sweeper as claimed in claim 5, wherein the upwardly extending flange includes a raised lip extending forwardly from the flange.

8. A sweeper as claimed in claim 5, wherein the flange is in the form of an upstand integrally formed with the mat.

9. A sweeper as claimed in claim 8, wherein the sweeper is formed as a set of modules which are lined together to form the sweeper, each module including a slot and an associated upwardly extending flange.

10. A sweeper as claimed in claim 5, wherein the sweeper includes a first upwardly extending flange serving as a barrier across the upper surface of the mat, and a second upwardly extending flange serving as a barrier across the upper surface of the mat.

11. A sweeper as claimed in claim 10, wherein the first upwardly extending flange is located forwardly of the second upwardly extending flange.

12. A sweeper as claimed in claim 10, wherein the first upwardly extending flange is parallel to the second upwardly extending flange.

13. A sweeper as claimed in claim 5, wherein the sweeper includes plurality of flanges, a plurality of slots, and each pair of successive flanges being separated by one of said slots.

14. A sweeper including a mat for sweeping a ground surface by moving the mat over the ground surface in a direction of travel substantially transverse to a leading edge of the mat, the mat having at least one slot extending therethrough and disposed transversely relative to the direction of travel whereby in use of the mat debris can pass through the slot over a trailing edge of the slot to collect on an upper surface of the mat, wherein the sweeper includes at least one riser at a front portion of the mat for raising a leading edge of the mat above the ground surface.

15. A sweeper as claimed in claim 14, wherein the at least one riser is in the form of at least one skid or wheel.

16. A sweeper as claimed in claim 1, wherein the sweeper includes a handle coupled to a leading edge of the mat for dragging the sweeper across the ground surface by hand or by a vehicle.

17. A sweeper as claimed in claim 16, wherein the handle is in the form of a rope coupled to opposed end portions of the leading edge of the mat.

18. A sweeper including a mat for sweeping a ground surface by moving the mat over the ground surface in a direction of travel substantially transverse to a leading edge of the mat, the mat having at least one slot extending therethrough and disposed transversely relative to the direction of travel whereby in use of the mat debris can pass through the slot over a trailing edge of the slot to collect on an upper surface of the mat, wherein the mat has apertures to allow infill collected by the sweeper from the ground surface to filter back down from the upper surface, through the apertures and onto the ground surface.

19. A sweeper including a mat for sweeping a ground surface by moving the mat over the ground surface in a direction of travel substantially transverse to a leading edge of the mat, the mat having at least one slot extending therethrough and disposed transversely relative to the direction of travel whereby in use of the mat debris can pass through the slot over a trailing edge of the slot to collect on an upper surface of the mat, wherein the mat has apertures to allow sand, rubber and/or other infill collected by the sweeper to filter back down from the upper surface, through the apertures and onto the ground surface.

20. A sweeper as claimed in claim 18, wherein the mat is of grid-like construction with an array of said apertures.

21. A sweeper as claimed in claim 1, wherein the sweeper includes at least one step extending as a hurdle rearwardly of the slot such that foreign object debris travels over the step by virtue of momentum and the step prevents unwanted forward travel of the debris.

22. A sweeper as claimed in claim 21, wherein the sweeper includes a plurality of steps extending as a hurdle rearwardly of the slot such that foreign object debris from the slot travels rearwardly over the steps by virtue of momentum and the steps prevent unwanted forward travel of the debris.

23. A sweeper as claimed in claim 22, wherein the steps are formed with a generally sawtooth profile, each tooth having a ramped forward face and a vertical rearward face.

24. A sweeper including a mat for sweeping a ground surface by moving the mat over the ground surface in a direction of travel substantially transverse to a leading edge of the mat, the mat having at least one slot extending therethrough and disposed transversely relative to the direction of travel whereby in use of the mat debris can pass through the slot over a trailing edge of the slot to collect on an upper surface of the mat, wherein the sweeper includes at least one step extending as a hurdle rearwardly of the slot such that foreign object debris travels over the step by virtue of momentum and the step prevents unwanted forward travel of the debris.
